(19) United States
(12) Patent Application Publication
(10) Pub. No.: US 2008/0016699 A1
(43) Pub. Date: Jan. 24, 2008

(54) Structure for fastening sword blade to scabbard

(76) Inventor: Kuo Chi Chang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/488,740

(22) Filed: Jul. 19, 2006

(51) Int. Cl. B26B 3/06

(52) U.S. Cl. 30/151; 30/298.4

(57) ABSTRACT

A structure for fastening sword blade to scabbard includes two magnets having different polarities and imbedded in a blade and a scabbard of a sword, respectively. The magnet imbedded in the blade is flush with an outer surface of the blade near a cross guard of the sword, and the magnet imbedded in the scabbard is flush with an inner surface of the scabbard corresponding to the magnet on the blade. With these arrangements, the sword blade may be easily inserted into and magnetically held to the scabbard without the risk of unexpectedly moving out of the scabbard, and may be smoothly drawn out from the scabbard without the risk of being stuck to the scabbard.

### FIELD OF THE INVENTION

The present invention relates to a structure for fastening sword blade to scabbard, and more particularly to a fastening structure including two magnets having different polarities for correspondingly imbedding in a sword blade and a scabbard, so as to magnetically hold the blade in the scabbard while allowing the blade to be smoothly drawn from the scabbard without being stuck thereto.

### BACKGROUND OF THE INVENTION

To prevent a blade from unexpectedly moving out of a scabbard of a sword, a sword manufacturer would usually try to produce the scabbard as highly matching with the sword blade as possible. While the sword blade is produced to highly match with the scabbard to avoid unexpected separation of the sword from the scabbard, it is also possible the sword blade is stuck to the scabbard and could not be smoothly drawn out from the scabbard. Moreover, the blade might become too tightly or loosely fitted in the scabbard due to errors in size and/or thermal expansion, and fails to be smoothly drawn out of the scabbard or securely received in the scabbard, respectively.

It is therefore tried by the inventor to develop an improved structure for fastening a sword blade to a scabbard to ensure that the sword blade is securely received in the scabbard and can be smoothly drawn out without being stuck to the scabbard.

### SUMMARY OF THE INVENTION

A primary object of the present invention is to provide a structure for fastening a sword blade to a scabbard, so that the sword blade is safely received in and retained to the scabbard without the risk of unexpectedly moving out of the scabbard, and can be smoothly drawn out from the scabbard as desired.

To achieve the above and other objects, the fastening structure of the present invention includes two magnets having different polarities and imbedded in the sword blade and the scabbard, respectively. The magnet imbedded in the sword blade is flush with an outer surface of the sword blade near a cross guard of a sword, and the magnet imbedded in the scabbard is flush with an inner surface of the scabbard corresponding to the magnet on the sword blade. With this arrangement, the sword blade may be easily inserted into the scabbard without the need of particularly aligning the blade with the scabbard, and may be drawn out of the scabbard smoothly without the risk of being stuck to the scabbard.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view showing a sword and a scabbard with the fastening structure according to the present invention;

FIG. 2 is a fragmentary enlarged view of FIG. 1; and

FIG. 3 is an assembled cross-sectional view showing the structure for fastening sword blade to scabbard according to the present invention.

### DETAILED DESCRIPTION OF THE PREFERRED EMBODIMENTS

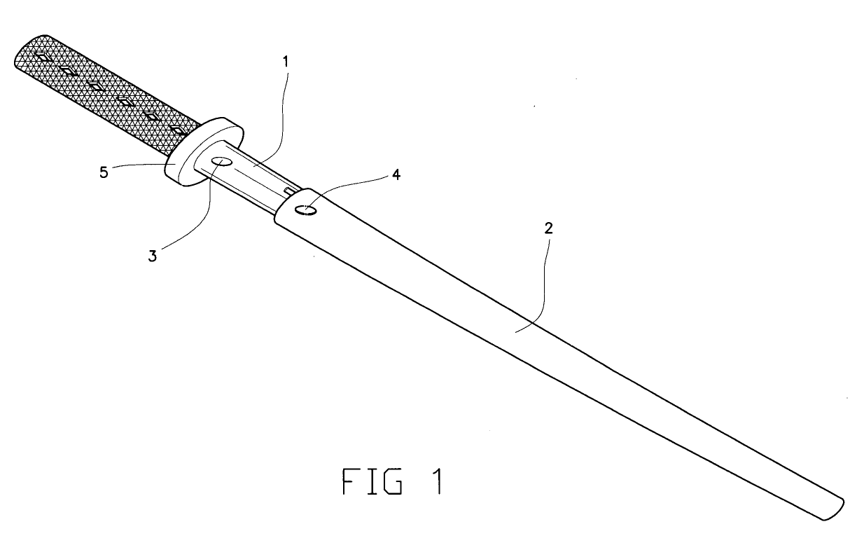

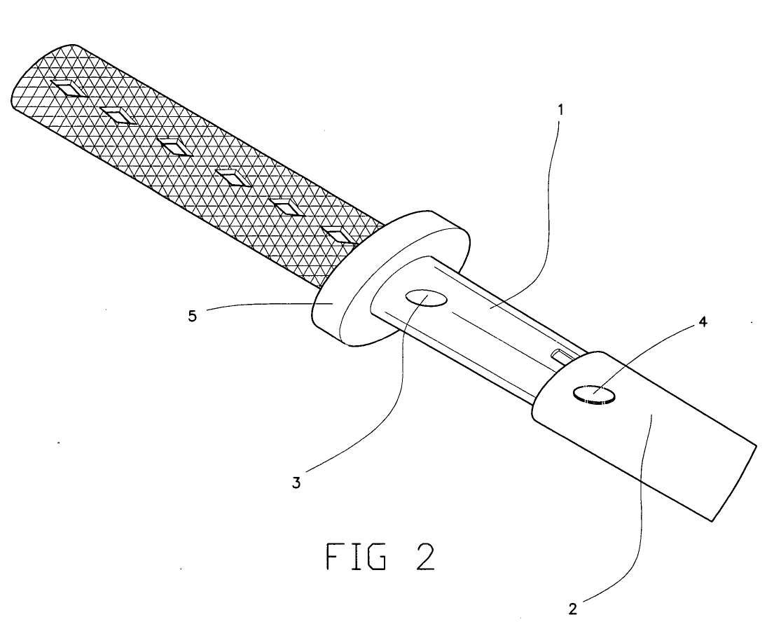

Please refer to FIGS. 1 and 2. The present invention relates to a structure for fastening a blade 1 to a scabbard 2 of a sword. The fastening structure is imbedded in the blade 1 and the scabbard 2. With the fastening structure of the present invention, the sword blade 1 received in the scabbard 2 is securely held to the scabbard 2, and may be smoothly drawn out of the scabbard 2 without the risk of being stuck to the scabbard 2.

The structure for fastening the sword blade 1 to the scabbard 2 according to the present invention includes a set of two magnets 3, 4 imbedded in the sword blade 1 and the scabbard 2, respectively. The two magnets have different polarities. That is, the magnet 3 has a positive polarity when the magnet 4 has a negative polarity, and vice versa. The magnet 3 is flush with an outer surface of the sword blade 1 near a cross guard 5 of the sword, and the magnet 4 is flush with an inner surface of the scabbard 2 near an opening thereof and corresponding to the magnet 3. With these arrangements, the blade 1 may be easily inserted into the scabbard 2 without the need of particularly aligning the blade 1 with the scabbard 2. When the blade 1 has been completely received in the scabbard 2, the magnet 4 naturally faces to the magnet 3 to magnetically attract and hold the blade 1 to the scabbard 2.

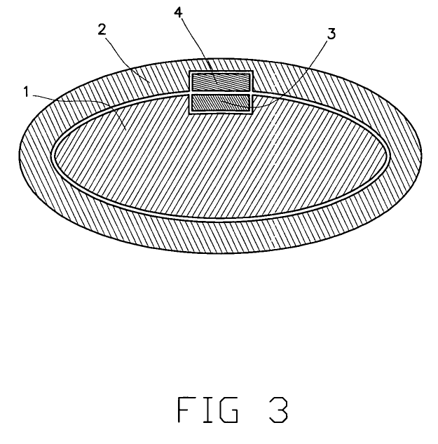

Please refer to FIG. 3. The magnet 3 is imbedded in the sword blade 1 to be flush with the outer surface of the blade 1, and the magnet 4 is imbedded in the scabbard 2 to be flush with the inner surface of the scabbard 2. It is noted the magnets 3 and 4 are correspondingly provided on the blade 1 and the scabbard 2 so as to face to each other when the blade 1 is completely received in the scabbard 2. With the magnet 3 imbedded in the blade 1 corresponding to the magnet 4 imbedded in the scabbard 2, the blade 1 fully received in the scabbard 2 is safely magnetically attracted to the scabbard 2 without the risk of unexpectedly moving out of the scabbard 2.

What is claimed is:

1. A structure for fastening sword blade to scabbard, comprising a first and a second magnet having different polarities, said first magnet being imbedded in a blade of a sword and flush with an outer surface of said blade near a cross guard of the sword, and said second magnet being imbedded in a scabbard and flush with an inner surface of said scabbard near an opening of said scabbard, such that said first magnet corresponds to said second magnet in position when said sword blade is fully received in said scabbard.
